(19) United States
(12) Patent Application Publication
(10) Pub. No.: US 2021/0172476 A1
(43) Pub. Date: Jun. 10, 2021

(54) RADIAL ROLLER BEARING CAGE

(71) Applicant: JTEKT CORPORATION, Osaka (JP)

(72) Inventor: Kotaro YAMASHITA, Kashiwara-shi (JP)

(73) Assignee: JTEKT CORPORATION, Osaka (JP)

(21) Appl. No.: 17/106,296

(22) Filed: Nov. 30, 2020

(30) Foreign Application Priority Data
Dec. 6, 2019 (JP) 2019-221413

(51) Int. Cl. F16C 33/46; F16C 19/28; F16C 33/56

(52) U.S. Cl. CPC F16C 33/467; F16C 19/28; F16C 33/56; F16C 2208/82; F16C 2220/04; F16C 2361/61; F16C 2220/24

(57) ABSTRACT

A radial roller bearing cage includes a pair of annular bodies; and a plurality of bars by which the annular bodies are axially connected to each other. The annular bodies and the bars are integrally formed by resin molding. A plurality of pockets separated from each other by the bars is provided between the annular bodies. A projection projecting radially inwardly is provided in at least one of parts of at least one of the annular bodies, the parts axially facing the pockets, respectively.

### CROSS-REFERENCE TO RELATED APPLICATION

This application claims priority to Japanese Patent Application No. 2019-221413 filed on Dec. 6, 2019, incorporated herein by reference in its entirety.

### BACKGROUND

### 1. Technical Field

The disclosure relates to a radial roller bearing cage made of resin.

### 2. Description of Related Art

In related art, some planetary gear devices used for transmissions of vehicles (e.g., automobiles) are configured such that a plurality of planetary gears is disposed between an external gear and an internal gear, and each of the planetary gears is rotatably supported by a radial roller bearing. The radial roller bearing includes a plurality of rollers and a cage configured to hold the rollers such that the rollers are rollable. Roller bearings used in planetary gear devices support rotation of planetary gears while the roller bearings receive centrifugal force caused by revolution of the planetary gears. Accordingly, in order to secure strength, cages made of metal have been widely used. However, due to request for weight reduction and cost reduction, there have been made attempts to employ cages made of resin (e.g., see Japanese Unexamined Patent Application Publication No. 2006-77801 (JP 2006-77801 A)).

A cage described in JP 2006-77801 A is configured such that two rib portions constituted by annular bodies facing each other at an interval in the axial direction of the cage and a plurality of bars arranged at predetermined intervals in the circumferential direction of the cage are integrally formed by use of a resin material. In each of the two rib portions, an annular core is embedded for improvement in strength. The annular core is made of a strength material higher in strength than the resin material. The core is made of a resin material combined with a metallic material such as rolled steel or reinforced fiber such as glass fiber.

### SUMMARY

In the cage described in JP 2006-77801 A, the core is embedded in each of the two rib portions, and therefore, man-hours at the time of manufacturing and weight increase. Although weight reduction and cost reduction are achieved in comparison with a metal cage, further weight reduction and further cost reduction have been requested. In consideration of the aforementioned circumstances, the inventor of the disclosure started to develop a resin cage having improved strength and found that the strength of the cage can be increased particularly by dispersing stress of annular bodies. Thus, the disclosure has been accomplished. That is, the disclosure provides a radial roller bearing cage made of resin and having improved strength.

One aspect of the disclosure relates to a radial roller bearing cage including a pair of annular bodies and a plurality of bars by which the annular bodies are axially connected to each other. The annular bodies and the bars are integrally formed by resin molding. A plurality of pockets separated from each other by the bars is provided between the annular bodies. A projection projecting radially inwardly is provided in at least one of parts of at least one of the annular bodies, the parts axially facing the pockets, respectively.

With the aspect of the disclosure, it is possible to improve the strength of the radial roller bearing cage made of resin.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an exploded perspective view illustrating a planetary gear device using a radial roller bearing including a cage according to an embodiment of the disclosure;

FIG. 2A is a sectional view illustrating a section of the roller bearing together with portions near the roller bearing;

FIG. 2B is a sectional view taken along a line II-II in FIG. 2A;

FIG. 3A is a side view of the radial roller bearing;

FIG. 3B is a front view illustrating an axial end face of the radial roller bearing;

FIG. 4 is a sectional view of the cage taken along a line IV-IV in FIG. 3A;

FIG. 5 is a perspective view illustrating one axial end of the cage;

FIG. 6 is a developed view schematically illustrating an inner peripheral surface of the cage, which is developed into a planar shape;

FIG. 7 is a stress distribution chart illustrating stress distribution caused in the cage of the radial roller bearing according to the embodiment; and

FIG. 8 is a stress distribution chart illustrating stress distribution caused in a cage of a radial roller bearing according to a comparative example.

### DETAILED DESCRIPTION OF EMBODIMENTS

### Embodiment

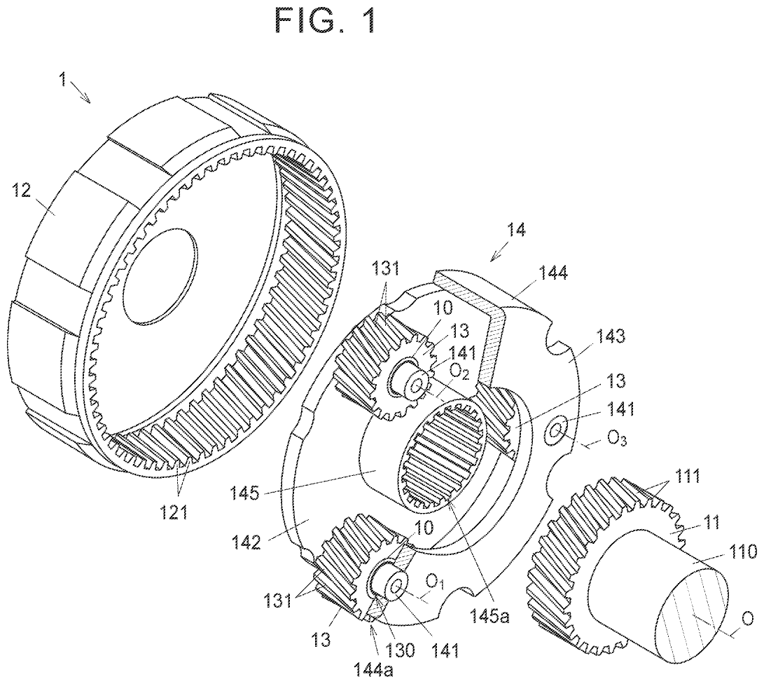

An embodiment of the disclosure will be described below with reference to FIGS. 1 to 7. Note that the embodiment described below shows a specific example of the disclosure. The technical scope of the disclosure is not limited to such a specific example.

Overall Configuration of Planetary Gear Device

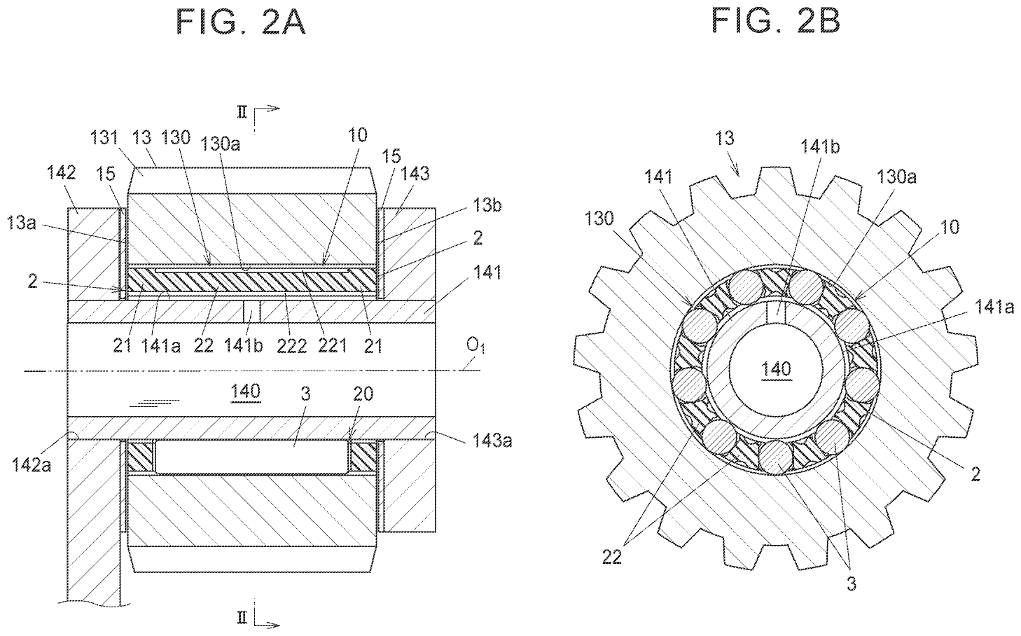

FIG. 1 is an exploded perspective view illustrating a planetary gear device using a radial roller bearing including a cage according to an embodiment of the disclosure. FIG. 2A is a sectional view illustrating a section of the roller bearing together with portions near the roller bearing, and FIG. 2B is a sectional view taken along a line II-II in FIG. 2A.

A planetary gear device 1 includes a sun gear 11 having external teeth 111 on its outer peripheral surface; an internal gear 12 having internal teeth 121 on its inner peripheral surface; a plurality of (three in the present embodiment) planetary gears 13 disposed between the sun gear 11 and the internal gear 12; a carrier 14 including a plurality of (three) support shafts 141 configured to support the planetary gears 13, respectively; radial roller bearings 10 (see FIGS. 2A, 2B) each disposed between a corresponding one of the planetary gears 13 and a corroding one of the support shafts 141; and a plurality of washers 15 disposed such that each of the washers 15 faces a corresponding one of axial end faces 13a, 13b of the planetary gears 13. The planetary gear 13 includes external teeth 131 meshing with the external teeth 111 of the sun gear 11 and the internal teeth 121 of the internal gear 12.

The sun gear 11, the internal gear 12, and the carrier 14 are supported to be coaxially rotatable relative to each other around a rotation axis O. Further, the planetary gears 13 rotate about respective rotation axes O₁ to O₃ around the support shafts 141. The planetary gears 13 revolve around the rotation axis O and rotate around the respective rotation axes O₁ to O₃. In FIGS. 2A, 2B, one planetary gear 13 rotating around the rotation axis O₁ is illustrated. Hereinafter, a direction parallel to the rotation axis O₁ is referred to as an axial direction, and a direction perpendicular to the rotation axis O₁ is referred to as a radial direction.

A shaft 110 is fixed to a central part of the sun gear 11 in a relatively non-rotatable manner. The planetary gear 13 is configured such that the support shaft 141 is inserted through a shaft hole 130 extending through a central part of the planetary gear 13, and the radial roller bearing 10 is disposed between an inner peripheral surface 130a of the shaft hole 130 and an outer peripheral surface 141a of the support shaft 141. The radial roller bearing 10 includes a cage 2 made of resin and a plurality of (nine in the present embodiment) rollers 3 made of metal. The rollers 3 are formed in a columnar shape and roll on the inner peripheral surface 130a of the shaft hole 130 of the planetary gear 13 and the outer peripheral surface 141a of the support shaft 141 along with rotation of the planetary gear 13.

The carrier 14 supports the planetary gears 13 via the radial roller bearings 10 such that the planetary gears 13 can rotate and revolve. Further, the carrier 14 includes first and second disk portions 142, 143 configured such that the planetary gears 13 are disposed between the first and second disk portions 142, 143 in the axial direction, an outer wall portion 144 configured to bridge respective end parts, on the outer peripheral side, of the first and second disk portions 142, 143, and a fitting tube 145 fixed to an end part, on the inner peripheral side, of the first disk portion 142.

A spline portion 145a to which a shaft (not shown) is fitted in a relatively non-rotatable manner is formed on the inner periphery of the fitting tube 145. An opening 144a is formed on the outer wall portion 144 such that part of the planetary gear 13 projects from the opening 144a. The external teeth 131 of the planetary gear 13 thus projecting from the opening 144a mesh with the internal teeth 121 of the internal gear 12. The washers 15 are each disposed between a corresponding one of the first and second disk portions 142, 143 and a corresponding one of the axial end faces 13a, 13b of the planetary gears 13.

As illustrated in FIG. 2A, both end parts of the support shaft 141 are respectively press-fitted into fitting holes 142a, 143a formed in the first and second disk portions 142, 143. The support shaft 141 has a cylindrical shape having a cavity 140 formed in its central part. An oil hole 141b communicating with the cavity 140 is opened on the outer peripheral surface 141a. Lubricant flowing into the cavity 140 is supplied to the radial roller bearing 10 from the oil hole 141b.

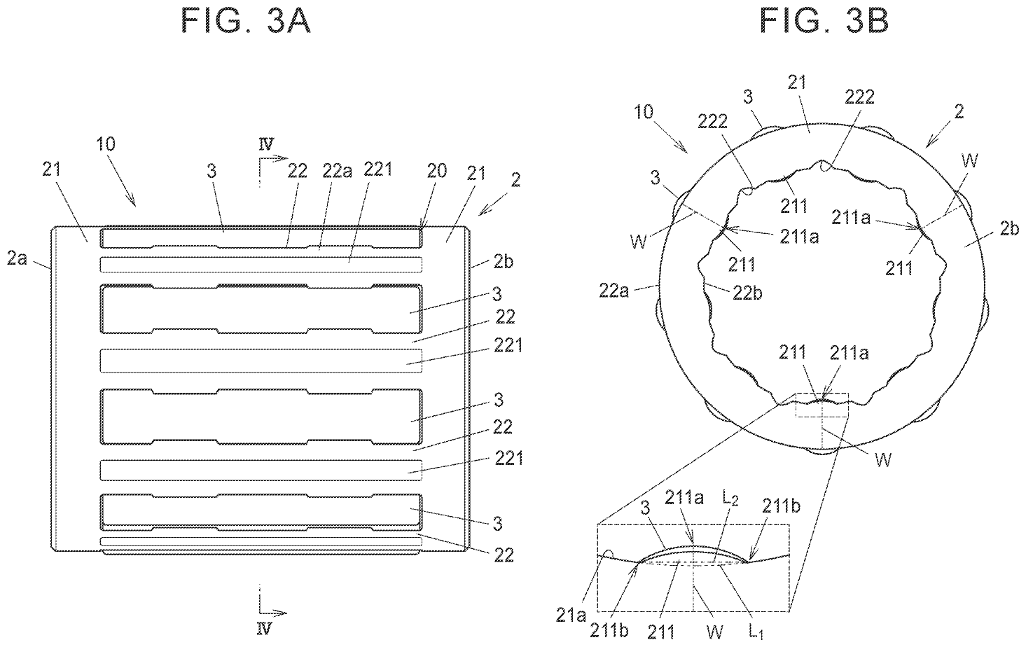

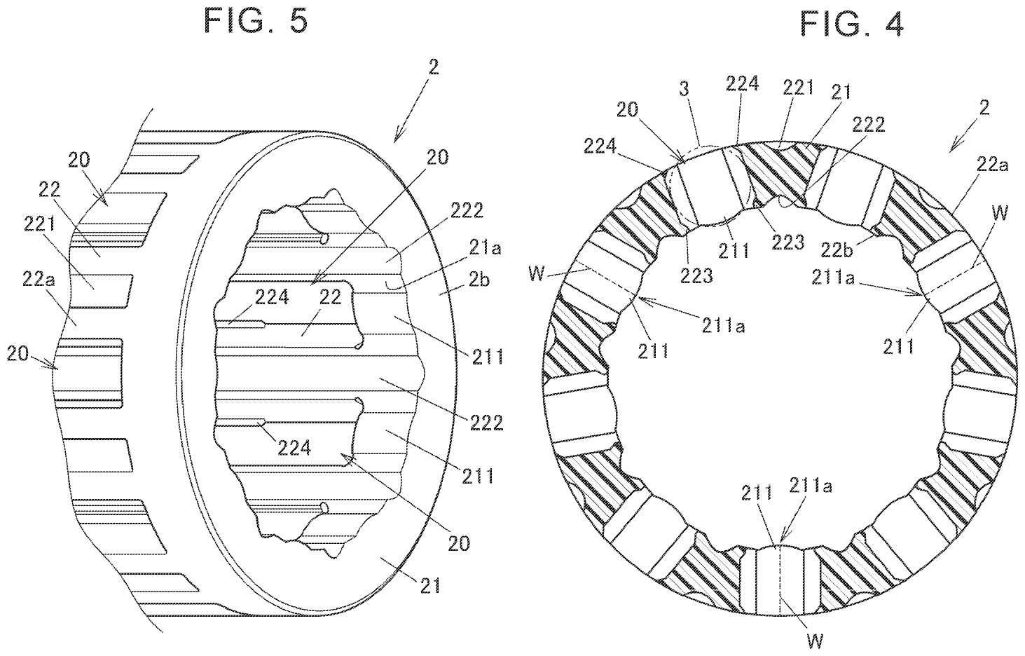

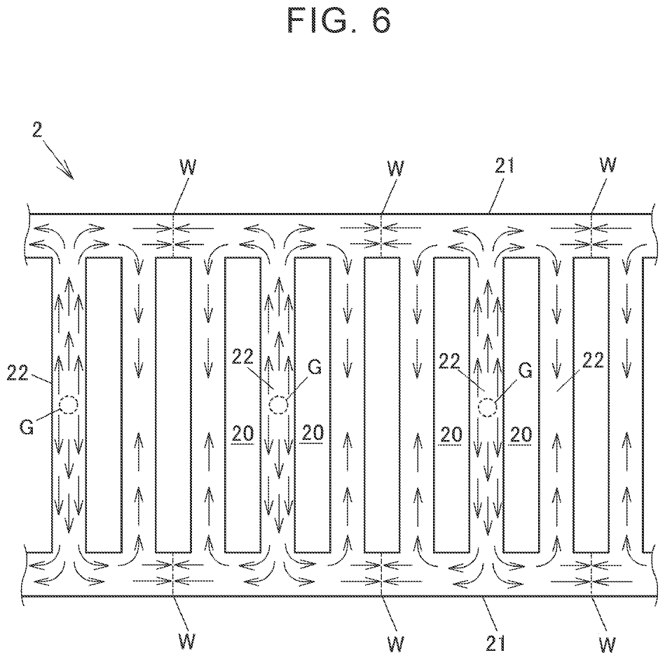

With reference to FIGS. 3A to 6, a configuration of the radial roller bearing 10 will described in detail. FIG. 3A is a side view of the radial roller bearing 10, and FIG. 3B is a front view illustrating an axial end face of the radial roller bearing 10. FIG. 4 is a sectional view of the cage 2 taken along a line IV-IV in FIG. 3A. FIG. 5 is a perspective view illustrating one axial end of the cage 2. FIG. 6 is a developed view schematically illustrating an inner peripheral surface of the cage 2, which is developed into a planar shape.

The cage 2 includes a pair of annular bodies 21 having a ring shape, and a plurality of bars 22 provided between the annular bodies 21. The annular bodies 21 are connected to each other in the axial direction by the bars 22 (i.e., the annular bodies 21 are axially connected to each other by the bars 22). The annular bodies 21 and the bars 22 are integrally formed by resin molding. In other words, the annular bodies 21 and the bars 22 are made of resin, and are integral with each other. As a resin material for the annular bodies 21 and the bars 22, nylon-66 obtained by adding a predetermined amount of a reinforced fiber material such as glass fiber or carbon fiber, polyphenylene sulfide (PPS) resin, or polybutylene terephthalate (PBT) resin can be appropriately used, for example.

A plurality of pockets 20 separated from each other by the bars 22 is provided between the annular bodies 21. The number of the bars 22 and the number of the pockets 20 are the same as the number of the rollers 3 included in the radial roller bearing 10, and in the present embodiment, nine bars 22 are provided at regular intervals along the circumferential direction of the annular bodies 21. Each of the pockets 20 is defined into a rectangular shape by two bars 22 adjacent to each other and the annular bodies 21. The annular bodies 21 have the same shape and the same size.

The rollers 3 are restrained from moving away from the pockets 20 by inner-peripheral-side and outer-peripheral-side projections 223, 224 (see FIG. 4) provided in the bars 22. FIG. 4 illustrates one roller 3 in a virtual line (an alternate long and two short dashes line). The distance between two bars 22 adjacent to each other is larger than the diameter of the roller 3 at the central part of the pocket 20 in the radial direction, and when the roller 3 is to be accommodated in the pocket 20, the bars 22 are elastically deformed.

On an outer peripheral surface 22a of each of the bars 22 in the cage 2, an oil groove 221 where lubricant flows is formed to extend in the axial direction. Further, on an inner peripheral surface 22b of each of the bars 22 in the cage 2, an oil groove 222 where lubricant flows is formed to extend in the axial direction. The oil groove 222 formed on the inner peripheral side of the bar 22 is formed in a linear shape within a range that reaches both axial end faces 2a, 2b of the cage 2, the range including respective inner peripheral surfaces 21a of the annular bodies 21.

The cage 2 is made of a single resin material. The cage 2 is formed by injection molding in which melted resin is injected into a metal mold. In FIG. 6, the flow of the melted resin when the cage 2 is formed by injection molding is indicated by a plurality of arrows, and a part corresponding to a gate through which the melted resin is injected is surrounded by a broken line and indicated by a reference sign G. In the present embodiment, the cage 2 is molded by injecting the melted resin into the cavity of the metal mold from three places at the same time.

As illustrated in FIG. 6, the melted resin injected from each of the gates G at the three places is divided into two directions and flows in the cavity. Then, the flows of the melted resin join each other at a plurality of places. In a meeting point at which the flows of the melted resin join each other (i.e., meet each other), a weld indicated by a reference sign W is formed (i.e., a weld W is generated). Here, the weld is a joint-shaped part that is inevitably formed when the flows of the melted resin hit and join each other, and the weld is a part having a strength lower than other parts. In the present embodiment, three welds W are formed in each of the annular bodies 21. In each of the annular bodies 21, a part where the weld W is formed is a part facing the pocket 20 in the axial direction.

When the carrier 14 rotates along with the rotation of the sun gear 11 or the internal gear 12, the cage 2 rotates around the support shaft 141 while the cage 2 receives centrifugal force caused by the revolution of the planetary gear 13. Therefore, the annular bodies 21 elastically deform into a substantially elliptical shape due to the centrifugal force, and thus, stress is caused therein. Particularly, when the stress concentrates on a part where the weld W is formed, breakage starting from the weld W easily occurs.

In view of this, in the disclosure, in order to improve strength by reducing stress concentration, a projection 211 projecting inwardly in the radial direction is provided in at least one of parts of at least one of the annular bodies 21, the parts respectively facing the pockets 20 in the axial direction. The projection 211 is provided at least at a position where the weld W is generated at the time of resin molding. In the present embodiment, the projections 211 are provided in parts of both of the annular bodies 21, the parts respectively facing both sides of all the pockets 20 in the axial direction.

As illustrated in FIG. 3B in an enlarged manner, the projection 211 has a curved shape projecting inwardly in the radial direction. In FIG. 3B, an extension line L₁ extending from the inner peripheral surface 21a of the annular body 21 is illustrated as an alternate long and two short dashes line that overlaps with a part where the projection 211 is formed. Further, in FIG. 3B, a straight line L₂ that connects both circumferential ends 211b corresponding to distal ends of the lower part of the projection 211 is illustrated as an alternate long and short dash line.

Each of the three welds W reaches an apex 211a having the highest projection height in the projection 211. That is, the weld W is formed over the whole projection 211 in its height direction (the radial direction). Here, the projection height indicates a distance from the extension line L₁ in the radial direction of the cage 2. The apex 211a projects inwardly in the radial direction beyond the straight line L₂, and a part of the roller 3 projects further inwardly in the radial direction beyond the apex 211a.

Note that, in the present embodiment, the circumferential width (the distance between both circumferential ends 211b) of the projection 211 is smaller than the opening width of the pocket 20 on the inner peripheral surface 22b, and the whole projection 211 is provided in the part facing the pocket 20 in the axial direction. However, the structure of the projection 211 is not limited to this structure, and a part of the projection 211 may be provided in a part facing the bar 22 in the axial direction. That is, both circumferential ends 211b of the projection 211 may be present at positions aligning with the bars 22 in the axial direction.

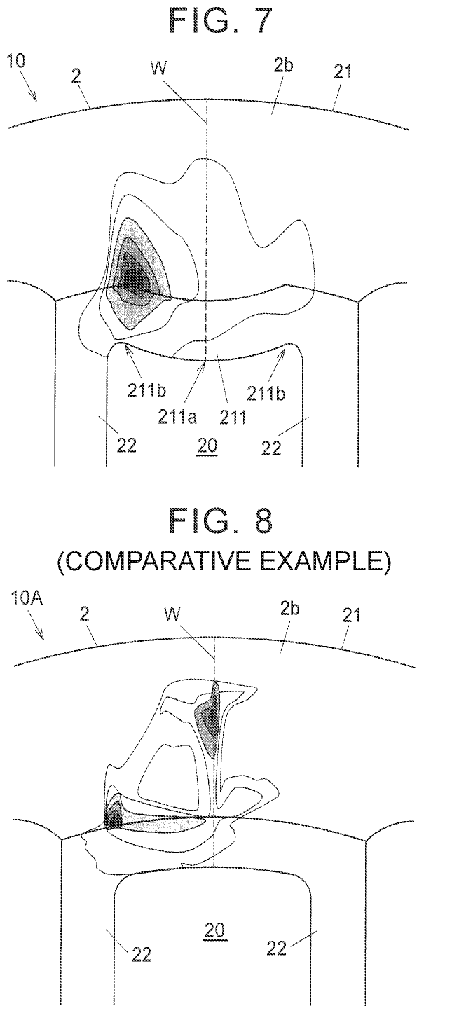

FIG. 7 is a stress distribution chart illustrating, by gray scale, stress distribution caused in the cage 2 when the radial roller bearing 10 according to the present embodiment is provided in the planetary gear device 1 and the planetary gear 13 revolves together with the carrier 14. FIG. 8 is a stress distribution chart illustrating, by gray scale, stress distribution when a radial roller bearing 10A according to a comparative example is used instead of the radial roller bearing 10. The radial roller bearing 10A according to the comparative example is configured similarly to the radial roller bearing 10 according to the present embodiment except that the cage 2 is not provided with the projections 211. Therefore, in FIG. 8, constituents of the radial roller bearing 10A are denoted by the same reference signs as those denoting their corresponding constituents of the radial roller bearing 10, and redundant descriptions are omitted.

In FIGS. 7, 8, the magnitude of stress is shown by depth of color. A part with deeper color has larger stress, and a part with lighter color has smaller stress. Note that, in FIGS. 7, 8, the relationship (scale) between the depth of color and magnitude of stress is the same.

As illustrated in FIG. 8, in the radial roller bearing 10A according to the comparative example, a part with large stress occurs in a central part, in the circumferential direction of the annular body 21, of a part facing one side of the pocket 20 in the axial direction such that the part with large stress extends along the radial direction. Since the weld W is formed in the part with large stress, breakage or the like easily occurs in the part where the weld W is formed.

In the meantime, in the radial roller bearing 10 according to the present embodiment, stress is dispersed in comparison with the radial roller bearing 10A according to the comparative example, and stress is greatly reduced in the part where the weld W is formed. Thus, breakage starting from the weld W can hardly occur, and thus, the strength of the cage 2 improves. Further, in the present embodiment, the projections 211 are provided in the parts respectively facing both sides of all the pockets 20 in the axial direction, the parts including the parts where the welds W are formed. Accordingly, stress concentration is reduced in the entire annular body 21 in the circumferential direction, and this also improves the strength of the cage 2.

The disclosure has been described based on the embodiment and its modification, but the embodiment and modification described above do not limit the disclosure.

Further, the disclosure can be carried out by appropriately modifying the embodiment by omitting some configurations or adding or replacing configurations within a range that does not depart from the scope of the disclosure.

What is claimed is:

1. A radial roller bearing cage comprising:
a pair of annular bodies; and
a plurality of bars by which the annular bodies are axially connected to each other, wherein:
the annular bodies and the bars are integrally formed by resin molding;
a plurality of pockets separated from each other by the bars is provided between the annular bodies; and
a projection projecting radially inwardly is provided in at least one of parts of at least one of the annular bodies, the parts axially facing the pockets, respectively.

2. The radial roller bearing cage according to claim 1, wherein the projection is provided at least at a position where a weld is generated at a time of the resin molding.

3. The radial roller bearing cage according to claim 1, wherein a weld reaches an apex having a highest projection height in the projection.
